(19) United States
(12) Patent Application Publication
(10) Pub. No.: US 2022/0107727 A1
(43) Pub. Date: Apr. 7, 2022

(54) SYSTEM AND METHOD FOR INPUTTING TEXT WITHOUT A MOUSE CLICK

(71) Applicant: Dojoit, Inc, San Jose, CA (US)

(72) Inventors: Tawhid Khan, San Jose, CA (US); Patrik Wijkstrom, Redwood City, CA (US)

(21) Appl. No.: 17/495,607

(22) Filed: Oct. 6, 2021

Related U.S. Application Data
(60) Provisional application No. 63/088,346, filed on Oct. 6, 2020.

(51) Int. Cl. G06F 3/0488; G06F 3/033; G06F 3/01

(52) U.S. Cl. CPC G06F 3/04883; G06F 3/016; G06F 3/033

(57) ABSTRACT

A method and system for inputting text on-site in a drawing or art software application are provided. The method includes identifying a drawing or art project initiated by a user on the drawing or art software application running on a computing device, detecting a Unicode keystroke from a keyboard interface of the computing device, responsive to the detection of the Unicode keystroke, determining a location of a mouse pointer inside a graphical user interface associated with the drawing or art project, and automatically creating a text object at the identified mouse pointer location without requiring the user to select a text tool from a tool section of the drawing or art software application.

### CROSS-REFERENCE TO RELATED APPLICATION

The application claims priority of U.S. provisional application No. 63/088,346 filed Oct. 6, 2020, which is hereby incorporated by reference in its entirety.

### TECHNICAL FIELD

The present disclosure is directed to systems and methods for text input, and in particular to systems and methods for inputting text without a mouse click in a drawing or art software application.

### BACKGROUND

In current drawing or art software applications, many different drawing and text tools are provided, to allow users to create and edit text objects (e.g., word, sentence, paragraph, symbol, etc.) and non-text objects (e.g., line, arrow, circle, square, image, etc.) in different formats and/or with different visual effects. While these different tools facilitate users in content creation and manipulation, it also requires users to frequently toggle between tools and objects or between different objects. Imaging a creation of a drawing or art project with 10 non-text objects and 8 text objects, for text object creation, current drawing or art software applications require a user to first select a text tool from a tool section of the drawing or art software application, next move a mouse to a target location to create a text object, and then type text into each object, all of which add up to 16 back-and-forth mouse movements for the text input. If considering that the real number of text objects in a drawing or art project may be much larger, and how many drawing or art projects are to be accomplished by users using the application, the time required for moving the mouse between drawing or text tools and text objects may be quite demanding, which unavoidably lowers productivity and increases time to complete drawing or art projects, thereby slowing down the efficient use of these drawing or art software applications.

### SUMMARY

To address the aforementioned shortcomings, a method and system for inputting text on-site in a drawing or art software application are provided. The method includes identifying a drawing or art project initiated by a user on the drawing or art software application running on a computing device, detecting a Unicode keystroke from a keyboard interface of the computing device, responsive to the detection of the Unicode keystroke, determining a location of a mouse pointer inside a graphical user interface associated with the drawing or art project, and automatically creating a text object at the identified mouse pointer location without requiring the user to select a text tool from a tool section of the drawing or art software application.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a block diagram of an example on-site text input system.

FIG. 2A is a block diagram of example modules of an on-site text input component.

FIG. 2B is a block diagram of example modules of another on-site text input component.

FIG. 3 illustrates an example process for text input in an existing drawing or art software application.

FIG. 4 illustrates an example process for on-site text input in a drawing or art software application with an on-site text input component.

FIG. 5 illustrates another example process for on-site text input in a drawing or art software application with an on-site text input component.

FIG. 6 is a flow chart of an example method for inputting text on-site in a drawing or art software application.

FIGS. 7A and 7B collaboratively illustrate a flow chart of another example method for inputting text on-site in a drawing or art software application.

FIG. 8 is a functional block diagram of an example computer system upon which aspects of this disclosure may be implemented.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high level, without detail, in order to avoid unnecessarily obscuring aspects of the present teachings.

The present disclosure provides a technical solution to address the technical problem of the low efficiency of text input in current drawing or art software applications. The technical solution allows a user in a drawing or art software application to input text without requiring the user to select a text tool, and allows a user to input text at the position of a mouse pointer without requiring the user to first click a mouse button or trackpad. That is, a user is not required to select a text tool nor click where to insert text when inputting text in a drawing or art software application. Instead, wherever a mouse pointer is located becomes the insertion point for the text. A user may invoke a text object on-site by a Unicode keystroke on a keyboard computer interface. Even if a user has already selected another non-text object, the user may type wherever the mouse pointer is located, without an unnecessary content switch (e.g., switch to a place without non-text objects).

The technical solution shows advantages over the existing drawing or art software applications. For example, the technical solution eliminates unnecessary and wasteful toggling between text tools and text and/or drawing objects in text objection creation, thereby increasing the efficiency of a user in a drawing or art project. In addition, the technical solution does not require a user to move away from non-text objects to create a text object, which then increases the flexibility of the user in placing a text object in a drawing or art project. Further, the technical solution allows a text object to be created through a very natural gesture (e.g., a keystroke), and thus allows a user to stay “in-the-flow” by keeping a focus on his/her content, minimizing distractions associated with toggling between text tools and text and/or drawing objects. Given the high frequency of text creation in drawing or art projects, even small individual efficiencies, fewer switches or toggles, and more natural gestures yield significant aggregate value. The technical solution, therefore, shows an improvement in the functioning of computers, particularly those with a drawing or art software application for frequent text and non-text object creation, editing, and visual effect manipulation, etc.

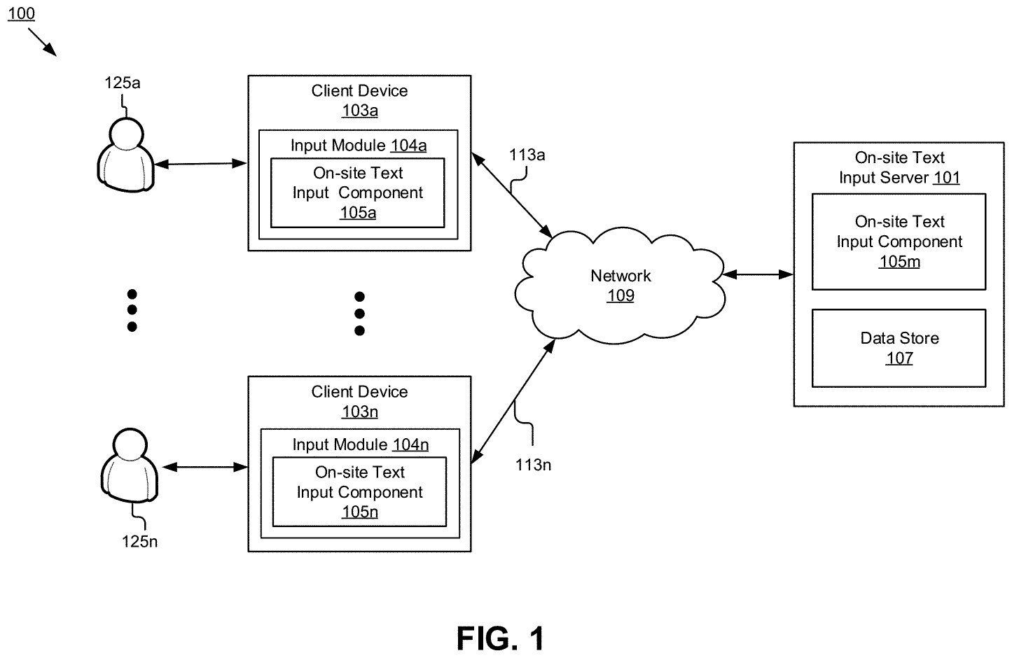

FIG. 1 is a block diagram of an example on-site text input system 100. As illustrated, the system 100 includes one or more client devices 103a . . . 103n, where each client device includes a respective input module 104a or 104n. Optionally, the on-site text input system 100 may further include an on-site text input server 101 communicatively coupled to the one or more client devices 103a . . . 103n via a network 109. Each instance of the input module 104a . . . 104n may further include an on-site text input component 105a . . . 105n. Optionally, an on-site text input component 105m may also be included in the on-site text input server 101. It is to be noted that FIG. 1 is provided by way of example and the system 100 and/or further systems contemplated by the present disclosure may include additional and/or fewer components, may combine components and/or divide one or more of the components into additional components, etc. For example, the system 100 may include any number of on-site text input servers 101, client devices 103a . . . 103n, or networks 109.

The network 109 may be a conventional type, wired and/or wireless, and may have numerous different configurations, including a star configuration, token ring configuration, or other configurations. For instance, the network 109 may include one or more local area networks (LAN), wide area networks (WAN) (e.g., the Internet), public networks, private networks, virtual networks, mesh networks, peer-to-peer networks, and/or other interconnected data paths across which multiple devices may communicate. The network 109 may also be coupled to or include portions of a telecommunications network for sending data in a variety of different communication protocols. In some implementations, the network 109 includes Bluetooth® communication networks or a cellular communications network for sending and receiving data including via short messaging service (SMS), multimedia messaging service (MMS), hypertext transfer protocol (HTTP), direct data connection, wireless application protocol (WAP), email, etc.

The client devices 103a . . . 103n (or collectively client device 103) may include virtual or physical computer processors, memor(ies), communication interface(s)/device(s), etc., which, along with other components of the client device 103, are coupled to the network 109 via signal lines 113a . . . 113n for communication with other entities of the system 100. In some implementations, the client device 103a . . . 103n, accessed by users 125a . . . 125n via input modules 104a . . . 104n respectively, may send and receive data to and from other client devices (s) 103 and/or the on-site text input server 101, and may further analyze and process the data. For example, the client devices 103a . . . 103n may communicate with the on-site text input server 101 to transmit user data including the user profile to the on-site text input server 101. The on-site text input server 101 may analyze the user profile to identify collaborators for the user for a drawing or art project. Non-limiting examples of client device 103 may include a laptop computer, a desktop computer, a tablet computer, a mobile telephone, a personal digital assistant (PDA), a mobile email device, or any other electronic device capable of implementing drawing or art software applications.

In some implementations, the client devices 103a . . . 103n include instances of input modules 104a . . . 104n (or collectively input module 104). The input module 104 is representative of functionality relating to inputs of the client device 103. For example, the input module 104 may be configured to receive inputs from a keyboard, mouse, trackpad, stylus, microphone, etc., to identify user inputs and cause operations to be performed that correspond to the user inputs, and so on. The inputs may be identified by the input module 104 in a variety of different ways. For example, the input module 104 may be configured to recognize an input received from a mouse, keyboard, or trackpad. These inputs may be referred to as physical inputs or hard inputs. For another example, the input module 104 may be configured to recognize an input received via touchscreen functionality of a display device, such as a finger of a user's hand or a stylus proximal to the display device of a client device 103, and so on. These inputs may take a variety of different forms, such as a tap, a snap, a drawing of a line by a finger or stylus, and so on. These inputs may also be referred to as gesture inputs or soft inputs. Other types of inputs are also possible and may be recognized by the input module 104. In some implementations, the input module 104 may be configured to differentiate between a gesture input (e.g., input provided by one or more fingers of a user's hand or a stylus) and a physical input (e.g., input provided by a keyboard, mouse, or trackpad).

In some implementations, the input modules 104a . . . 104n include instances of on-site text input components 105a . . . 105n (or collectively on-site text input component 105). The on-site text input component 105 may be configured to enable an on-site text input. For example, the on-site text input component 105 may enable a client device 103 to receive a Unicode keystroke on a keyboard (physical keyboard or virtual keyboard) interface, and create a text object on-site at the location of a mouse pointer, or the location where a finger or stylus touches most recently if a gesture input is employed, and continue capturing Unicode keyboard input into the created text object. Here, Unicode keyboard input or Unicode keystroke may refer to a press of one of an alphanumeric key (e.g., 1, 2, 3, a, b, c) and a punctuation key (e.g., ;, ', ., /). In some implementations, the on-site text input server 101 may also include an instance of on-site text input component 105m, as illustrated in FIG. 1. In some implementations, the on-site text input component 105 may be a standalone software application, or be part of a drawing or art software application, or be part of another software and/or hardware architecture (e.g., a social network platform).

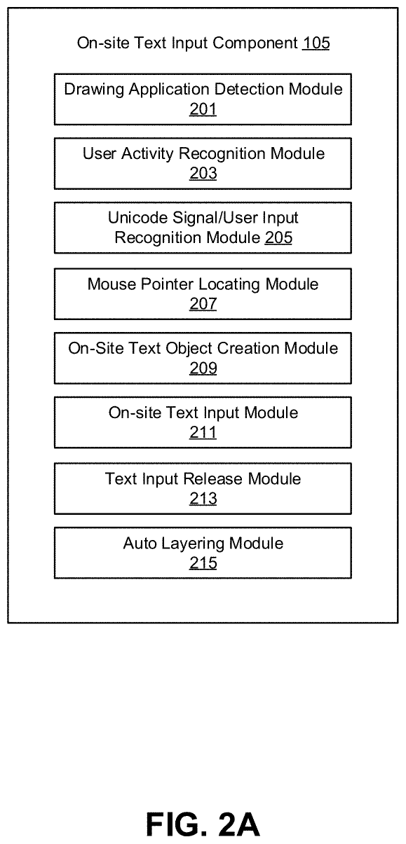

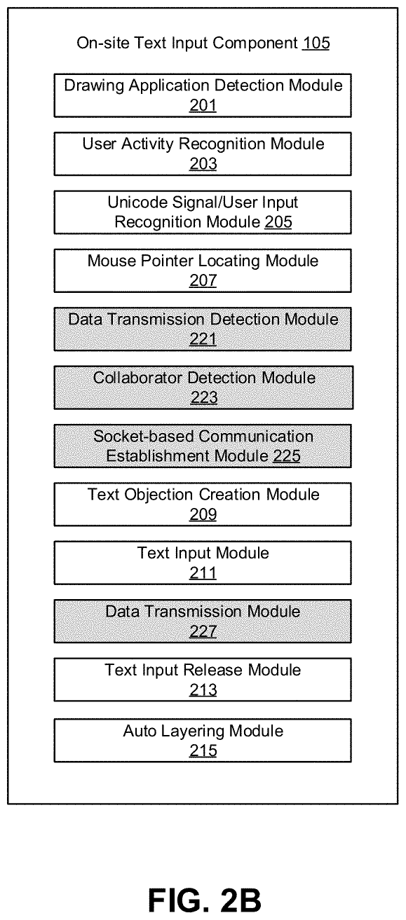

In some implementations, each instance of on-site text input components 105a . . . 105n includes one or more modules as depicted in FIG. 2A or FIG. 2B, and may be configured to fully or partially perform the functionalities described therein depending on where the instance resides. In some implementations, the on-site text input server 101 may be a cloud server that possesses larger computing capabilities and computing resources than a client device 103n, and therefore may perform more complex computation than the client device 103n can. For example, the on-site text input component 105 may perform a decision process to determine whether a user is inputting text on a region related to a drawing or art software application, or on a region outside such application. Depending on where a mouse pointer is located, the on-site text input component 105 may determine whether or not to create a text object. For another example, the on-site text input component 105 may be configured to determine whether there is a collaborator(s) for a user for an ongoing drawing or art project. The on-site text input component 105 will be described in more detail below with reference to FIGS. 2A-2B.

FIG. 2A is a block diagram of example components of an on-site text input component 105 according to some implementations. As illustrated, the on-site text input component 105 may include a drawing application detection module 201, a user activity recognition module 203, a Unicode signal/user input recognition module 205, a mouse pointer locating module 207, an on-site text object creation module 209, an on-site text input module 211, a text input releasing module 213, and an auto layering module 215.

The drawing application detection module 201 is configured to detect a drawing or art software application running on a client device 103, and the associated region where the application resides on a display screen of the client device 103. The user activity recognition module 203 is configured to recognize or monitor keypress events and other user activities of a user on a client device 103, e.g., recognize that the user is using a Pen tool or Shape tool, or recognize that the user is drawing a line or a certain shape. The Unicode signal/user input recognition module 205 is configured to recognize certain user inputs (e.g., a Unicode signal/user input) that trigger creation of a text object. For example, the Unicode signal/input recognition module 205 may recognize that a user starts typing through a keyboard interface without clicking his/her mouse button, which then triggers the creation of a text object on-site (i.e., at a place where the mouse pointer is located). The mouse pointer locating module 207 is configured to determine where a mouse pointer is currently located (in x/y coordinates of a display screen) in realizing that a text object is to be created on-site. In some implementations, if gesture inputs are being received from a touch interface (e.g., a touch screen), the mouse locating module 207 may locate where a previous touch point resides on the touch interface if a user is currently typing through a virtual keyboard displayed on the touch interface. The on-site text object creation module 209 is configured to automatically create a text object. The on-site text input module 211 is configured to continuously capture Unicode keyboard inputs into a created text object. For example, the on-site text input module 211 allows a user to continuously input text into a newly created text object. In some implementations, the on-site text input module 211 also automatically and dynamically adjust the size of the created text object, to accommodate the text input into the text object. The text input ending module 213 is configured to end text input into the created text object if a user clicks (e.g., a mouse release) outside the created text object or presses the escape (Esc) button on the keyboard. This then ends the on-site text input process, and thus generates a new text object that can be integrated into a drawing or art project. In some implementations, the on-site text input component 105 may further include an auto layering module 215 configured to automatically arrange Z-index (e.g., bottom-to-top arrangement of objects with respect to a display user interface) of layers of text and non-text objects in a drawing or art project according to a predefined pattern. For example, once a new text object is generated, the auto layering module 215 may identify the size of the newly generated text object, and place the text object in a Z-index position according to the identified size of the text object. The specific functions of each module 201-215 are described further in detail as follows.

The drawing application detection module 201 may be configured to detect any drawing or art software application running on a client device 103. These drawing or art software applications may include any software application that combines text objects with other non-text objects for drawing or art applications. Here, a text object may be a textual component that includes certain numbers, characters, and symbols organized in a predefined structure (e.g., as a sentence, paragraph, in a box, etc.). A non-text object may include non-textual structures such as certain shapes, lines, images, etc., that are organized in a specific pattern. Some exemplary drawing or art software applications may include, but are not limited to, certain presentation programs such as PowerPoint®, Google Slides®, computer-aided design (CAD) programs such as AutoCAD®, and graphics editors such as Adobe Photoshop®, Adobe Illustrator Draw®, Visio®, Sketchpad®.

In some implementations, the drawing application detection module 201 may compile a list of software or art software applications that combine both text objects and non-text objects, and rely on such a list to determine whether a drawing or art software application is running on a client device 103. For example, the drawing application detection module 201 may check the software programs that currently run on a client device 103 and compare these software programs to the compiled list to determine whether a drawing or art software application is running on the client device 103. Other methods of identifying a running drawing or art software application are also possible and are contemplated. In some implementations, after confirming a drawing or art software program running on a client device, the drawing application detection module 201 may further determine a region covered by the program on a display screen. This then ensures that the on-site text input function is enabled in a region within the drawing or art software program region, but not outside the program region. In some implementations, the drawing application detection module 201 or the whole on-site text input component 105 may be integrated into an existing drawing or art software application as an extension or plug-in tool, which also facilitates detection of the associated drawing or art software application running on a client device 103.

The user activity recognition module 203 may be configured to monitor user activities of a user on a client device 103. In some implementations, the user activity recognition module 205 may specifically monitor user activities related to a drawing or art software application, e.g., keypress events, mouse movements, mouse clicks, etc. Input devices generally contain a trigger, e.g., a mouse click button, a pressing or releasing key, which may be used to send a signal to an operating system or a related application running on the operating system. When triggered, the input devices may return information (e.g., their measures) to the operating system or the running application. For instance, a mouse may return position information, and a keyboard may return an ASCII code. Based on the signals returned from the input devices, user inputs may be then determined. The user activity recognition module 203 may then recognize user activities related to a drawing or art software application based on the user inputs. In some implementations, if a touch display and gesture input are employed, the corresponding signals may be also returned to the operating system and/or the related application responsive to the user inputs. Based on the received signals, the user inputs or other activities may be also similarly recognized.

The Unicode signal/user input recognition module 205 may be configured to recognize certain user inputs that invoke an on-site creation of a text object. The Unicode signal/user input recognition module 205 may identify a special Unicode signal among the signals returned from the input devices corresponding to user inputs. For example, for a drawing or art software application running on a client device 103, if a user input is a pressing of an alphanumeric key (e.g., a character, number, or symbol on a keyboard) or a punctuation key (for punctuations), the corresponding signal may be then recognized by the operating system and/or the related application. Once such signal is received, the Unicode signal/user input recognition module 205 may recognize that a user intends to input text on the ongoing drawing or art project.

The mouse pointer locating module 207 may be configured to determine where a mouse pointer is currently located (in x/y coordinates of a display screen) in realizing that a text object is to be created on-site to take text input from a user. As described above, once clicked, dragged, released, etc., a mouse may return a signal including a measure of the location information to the operating system and/or the related application. Based on such measures, a location of a mouse pointer may be determined by the mouse pointer locating module 207. In some implementations, if a gesture input is used instead on a client device 103, a location identification component may be also included in such device. For instance, a digitizer may be included in a touch screen device, where the digitizer may use a capacitance technique to sense the location of a user's hand and/or a stylus used by the user. Alternatively, and/or additionally, one or more cameras within a touch screen device may detect the position of a user's finger and/or a stylus from a gesture input. The camera(s) may optionally include a depth camera system that uses a time-of-flight technique, a structured light technique, a stereoscopic technique, etc., to capture a depth image of a user's hand and/or stylus. Alternatively, and/or additionally, an inertial measurement unit (IMU) associated with a stylus may detect the position of the stylus. The IMU may include any combination of one or more accelerometers, gyroscopes, magnetometers, etc. Still, other techniques for detecting the location of a user's hand and/or stylus may be used. Based on the techniques implemented inside a client device, the mouse pointer locating module 207 may similarly determine a most recent touch point of a finger or stylus, which may be the position where a user intends to input text.

The on-site text object creation module 209 may be configured to automatically create a text object on a location recognized by the mouse pointer locating module 207. The on-site text object creation module 209 may create a text object on-site without requiring a user to click any text tools in a drawing or art software application. In addition, the on-site text object creation module 209 may be triggered to create a text object even without a click by a user in the intended location. For instance, the on-site text object creation module 209 may allow a user to create a text object by just keystroking a Unicode signal/text input through a keyboard, like a normal typing of a text input. This is a very natural gesture (e.g., a keystroke) for text input for a user, which then allows a user to stay “in-the-flow” by keeping a focus on their content, minimizing distractions associated with toggling between text tools and text and/or drawing objects. In some implementations, a text object may be created even at a location where there is a non-text object. That is, a text object may be created by overlaying with an existing non-text object, which then increases the flexibility of a user in placing text objects in a drawing or art project. In some implementations, the on-site text object creation module 209 may ensure that a text object would be not accidentally created outside a graphic user interface (GUI) associated with the corresponding drawing or art application. The on-site text object creation module 209 may achieve this by checking whether the determined mouse pointer location is within a work area (e.g., GUI) for a drawing or art software application.

The on-site text input module 211 may be configured to continue capturing text inputs through Unicode keystrokes by a user. While not visually noticeable as other text objects created through text tools, a newly created text object may be still recognized once a first string/Unicode character occurs at a determined mouse pointer location right. The new text object, once created, may allow a continuous text input into the created object. That is, the created text object may maintain active if a user keeps typing or inputting text into the created object. In some implementations, there is no limitation on the size of a created text object, as long as a text object does not spread beyond the GUI associated with a drawing or art project. In some implementations, the font of the inputted text may have a default type (e.g., Times New Roman) and size (e.g., 12). In other implementations, the font of the inputted text may be predefined and/or personalized. In some implementations, the font of the inputted text may be timely selected or modified by a user inputting the text. In some implementations, the font size of the inputted text may be dynamically adjusted to accommodate the content of the inputted text if the active area for text input is limited. In some implementations, the inputted text may be automatically aligned on the left when there are multiple lines, so that inputted text only appears on the light of the determined mouse pointer location. It is to be noted that the above implementations are merely for illustrative purposes, and not for limitation.

The text input ending module 213 may be configured to end text inputting into a created text object base on a specialized user input. The specialized user inputs may include, but is not limited to, a user click (e.g., a mouse release) outside the created text object (e.g., on the left side or upper side of the identified mouse pointer location for the creation of the text object), a press of a certain button (e.g., Esc button) on a keyboard interface, a quick double click of a mouse, a certain period of time without text inputting (e.g., 5 min, 10 min, 15 min), etc. Other types of specialized user inputs may be also defined for ending the text inputting process into a created text object. Once a specialized user input is identified, the text input ending module 213 may end text inputting into the created text object, for example, by not taking additional text inputting into the newly created text object. A real text object may be then generated, which may be manipulated together as a single object or a single item in a drawing or art project. For instance, the generated text object may be moved as a single piece of element and reorganized with other text and non-text objects.

The auto layering module 215 may be configured to automatically layer different text objects and non-text objects according to a predefined pattern. In some implementations, a newly created text object may intersect with other existing text or non-text objects included in a drawing or art project if they are placed in a same Z-index layer. Too much intersection may cause certain problems in manipulating (e.g., editing or moving) these different objects. Accordingly, some created text objects (or other text or non-text objects) may be overlaid with other text or non-text objects as a single Z-index layer (or may be combined with other objects into a single layer if possible). The auto layering module 215 may then automatically layer different text or non-text objects according to a predefined pattern. For instance, different objects in a drawing or art project may be arranged according to the size (e.g., object area obtained by height*width) of each layered object, although certain parameters may be explored for arranging the different layers of objects. Here the following is one exemplary PSEUDOCODE for auto layering objects by the auto layering module 215:

GET all objects from canvas
REPEAT

GET objects who intersect with each other
IF one object intersects with another THEN
CALCULATE the intersecting percentage depending on objects' X,
Y Co-ordinates on canvas
IF intersecting percentage GREATER THAN 15

SET Intersecting objects to an array
CALCULATE objects area (Height * Width)
FOR all objects in the array

IF area of object ‘A’ GREATER THAN area of object ‘B’
THEN

SEND object ‘A’ backward (Largest to the back)

ENDIF

ENDFOR

ENDIF
SET the array to empty

UNTIL all intersecting objects are layered according to their area size
RE-RENDERING the whole canvas for the updated view with sorted
objects

It is to be noted the above-described modules are merely for illustrative purposes, and the disclosed on-site text input component 105 may include more or fewer components or modules than those illustrated in FIG. 2A. For example, in some implementations, the on-site text input component 105 may include one or more modules or components configured to share input text with other collaborators so that a drawing or art project may be collaborated between different users. One such implementation of an on-site text input component 105 is further described in detail below.

FIG. 2B is a block diagram of example components of an on-site text input component 105 according to other implementations. As illustrated, the on-site text input component 105 may include a drawing application detection module 201, a user activity recognition module 203, a Unicode signal/user input recognition module 205, a mouse pointer locating module 207, an on-site text object creation module 209, an on-site text input module 211, a text input releasing module 213, and an auto layering module 215 as described above with reference to FIG. 2A. In some implementations, an on-site text input component 105 may further include a data transmission detection module 221, a collaborator detection module 223, a Socket-based communication establishment module 225, and a data transmission module 207, as illustrated in FIG. 2B.

In some implementations, a drawing or art project can be collaborated between different users. For instance, one user (also referred to as “host”, who may be a board owner or another person who is a member of the board) may initiate a drawing or art project in a drawing or art software application, and then send the ongoing project to another user (also referred to as “collaborator”) for opinions, comments, or even edits. The ongoing project may be sent by a host to a collaborator in real-time, that is, any text typing in a drawing or art project may be sent to the collaborator in real-time so that the collaborator can see what is being typed by the host. In response, the collaborator may provide comments through a social network platform, or may directly input text into an active text object from his/her side, and the entered text may be transmitted back to the host and displayed to the host. To enable project collaboration on a client device 103 (either a host device or a collaborator device), an on-site text input component 105 on the client device may include a data transmission detection module 221 configured to check whether data can be transmitted at the moment of the expected collaboration. In addition, the on-site text input component 105 may also include a collaborator detection module 223 configured to detect whether there is a collaborator available for collaboration. A Socket-based communication establishment module 225 may be also included in the on-site text input component 105 to prepare for data transmission in expectation of a project collaboration. Further, a data transmission module 227 may be included in the on-site text input component 105 to transmit data between the host and collaborator during the project collaboration. Specific functions of each module 221-227 are further described in detail as follows.

The data transmission detection module 221 may be configured to detect a real-time data transmission capacity of a client device 103 (e.g., a host device or a collaborator device). For instance, the data transmission detection module 221 may check whether a client device is equipped with transmission channels such as a cable, Wi-Fi, or any other wireless transmission in a network. The data transmission detection module 221 may further check whether at least one transmission channel is enabled if there is any. In some implementations, the data transmission detection module 221 may also detect whether a host has a permission to transmit the data for collaboration. For instance, a service provider for a drawing or art software application may require a purchase of a license of a certain service if a user hopes to collaborate with others for a drawing or art project. Accordingly, before actual data transmission, the data transmission detection module 221 may check the user profile of the host and/or any potential collaborator before the data transmission.

The collaborator detection module 223 may detect whether a collaborator is available for collaboration on an ongoing drawing or art project in a drawing or art software application. The collaborator detection module 223 may determine whether a collaborator is available based on the status of the collaborator in a chatting board included in a drawing or art software application, or another third-party social network platform that is integrated into the drawing or art software application (e.g., as an extension or plug-in tool), or with the on-site text input component 105 embedded in a third-party social network platform instead. Through whatever platform, the collaborator detection module 223 may identify the available collaborators for collaboration. In some implementations, the collaborator detection module 223 may additionally check the user profile of the host or based on a user selection to identify a preferred collaborator if multiple collaborators are available. Additionally and/or alternatively, more than one collaborator may be identified to collaborate, or everyone interested in collaboration can participate.

The socket-based communication establishment module 225 may be configured to establish a Socket communication channel that allows for the real-time transfer of data from a client device 103 to a server side (e.g., an on-site text input server 101) and from the server side to a client side once such channel is established. This connection may persist until the channel is terminated. Unlike the HTTPS protocol, Socket allows for data transfer in both directions. Socket, once established, may be used to build out anything that requires efficient, real-time data transfer, such as a chat application in a third-party social network platform, or a real-time transmission of an active drawing or art project as further described below. In some implementations, each client device 103, either a host device, a collaborator device, or a server may be configured with a Socket-based communication. This then allows the real-time data transmission to be established and maintained between the host, the server, and/or the collaborators.

The data transmission module 227 may be configured to transmit data including an active drawing or art project between a host device and a collaborator device or a server. For instance, the data transmission module 227 may transmit each typing Unicode character (e.g., each character, number, or symbol) inputted by a host in real-time, so that a collaborator can instantly see what the host is typing during the collaboration. In some implementations, a temporary text field may be created on a host side and/or on a client side so that text input by the host is momently shown to the collaborator(s). Once the text input is ended for a created text object, a real text object may replace the temporary text field shown to the collaborator, and a data transmission between the host and collaborator may be then ended and the Socket-based communication channel is terminated.

It is to be noted that the on-site text input component 105 illustrated in FIG. 2B may also include other elements such as modules 201-215 as described in FIG. 2A. In addition, a client device 103 associated with a collaborator may include a similar configuration, which then allows the collaborator device to instantly input text on-site on a collaborating project. This then allows the whole collaboration much smoother and more efficiently, since a host or collaborator does not need to toggle between the text tools and text objects and/or drawing objects that may delay an instant response from collaborator(s). Therefore, the on-site text input component 105 shows clear advantages over other existing drawing or art software applications.

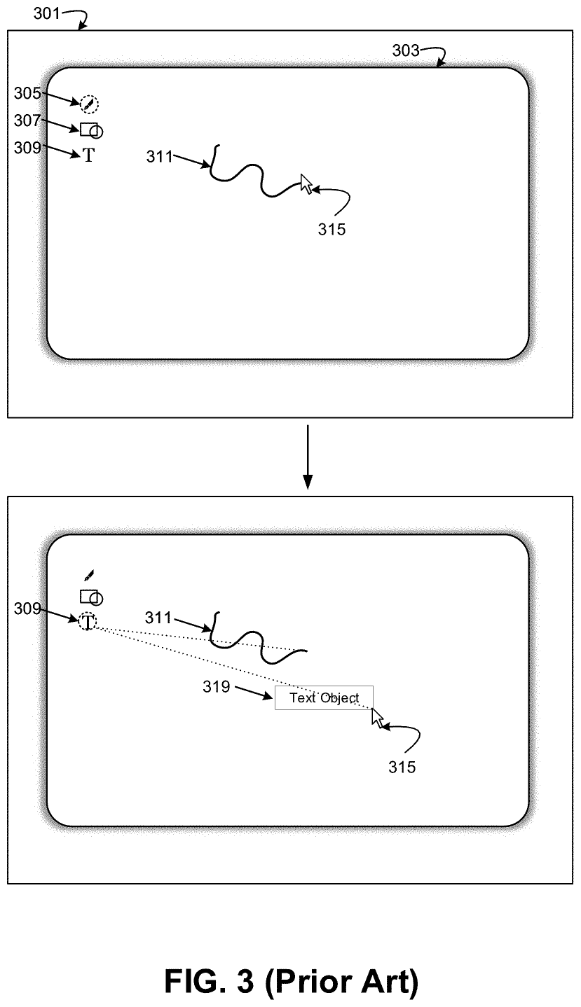

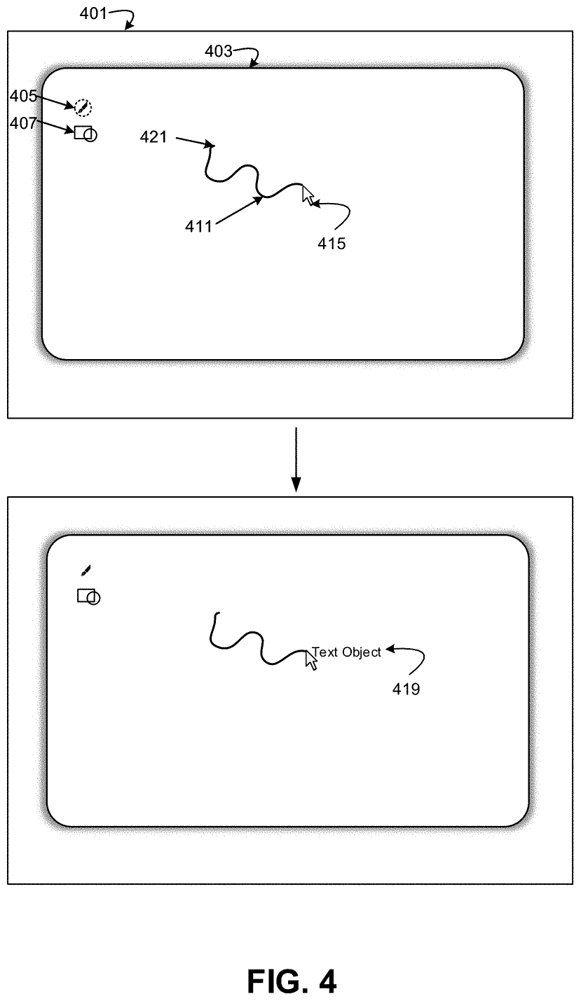

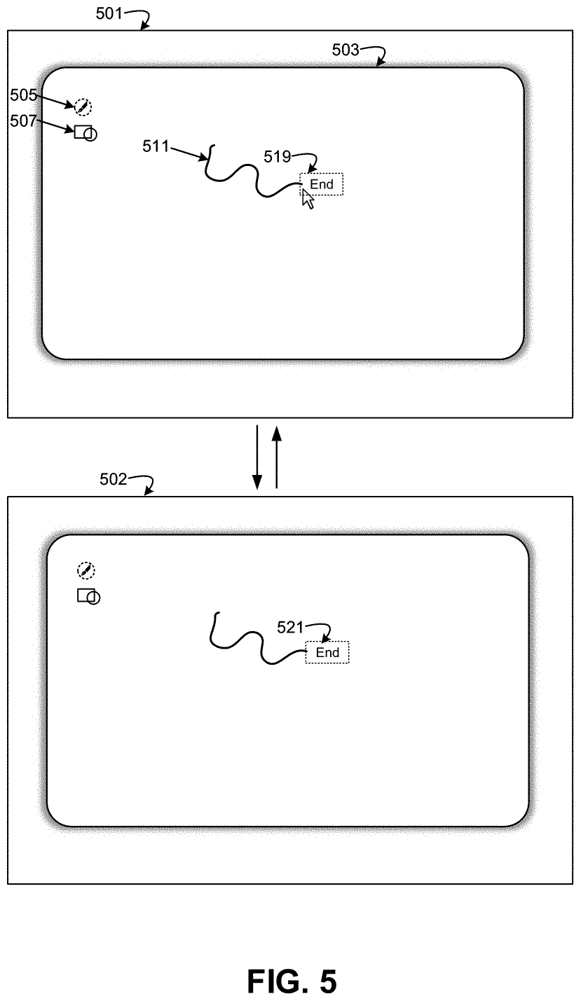

FIG. 3 shows an exemplary text input process in an existing drawing or art software application, FIG. 4 shows an exemplary on-site text input process in a disclosed drawing or art software application running on a single device, and FIG. 5 shows an exemplary on-site text input process in a collaborating environment.

In FIG. 3, a drawing or art software application is running on a client device, for example, an application window 303 is showing on a display screen 301 of the client device. The drawing or art software application may include a plurality of tools for drawing, text input, etc. For example, as illustrated in the upper part of FIG. 3, the drawing or art software application may include a drawing tool 305, an editing tool 307, and a text tool 309, where each tool may include a subset of tools (not shown) for specific functions in each aspect. At one moment, a user wants to draw a line, so the user selects the drawing tool 305 by moving his/her mouse to the corresponding position of the drawing tool, as indicated by the dotted circle around the drawing tool 305. The user may then begin to draw a line by moving the mouse to an area for drawing. After a line 311 is drawn, the mouse stops at an ending position of the drawn line 311, as indicated by the position of the mouse pointer 315 displayed on the display screen. At this moment, the user may want to input certain text for his/her project. The user may then move the mouse from the current position to the tool section and select the text tool 309, as indicated by the dotted circle in the lower part of FIG. 3. After the selection of the text tool 309, the user may again move the mouse back to a drawing area and place the mouse pointer to a position that he/she wants to input text (the movements of the mouse during the text tool selection are indicated by the dotted lines in the lower part of FIG. 3). As can be seen from the lower part of FIG. 3, the user may be required to select a position that is not occupied by the drawn line 311, since the drawing or art software application may not allow an overlay of a text object with a non-text object. The user may create the text object at that location by clicking the mouse again. A text object 319 is then created, as indicated by a box, which then allows the user to input text in the created text object. As can be seen, to input text, the user needs to operate the mouse at least three times, including moving or clicking the mouse. If the text object creation can be performed on-site as further described in FIGS. 4-5, a user may not operate the mouse at all, which greatly saves the time of the user.

FIG. 4 shows an exemplary on-site text input process, in which a user does not need to move or click a mouse to create a text object in a drawing or art project. In FIG. 4, a drawing or art software application is running on a client device 103, for example, an application window 403 is showing on a display screen 401 of the client device. The drawing or art software application may include a plurality of tools for drawing. For example, as illustrated in the upper part of FIG. 4, the drawing or art software application may include a drawing tool 405 and an editing tool 407, where each tool may include a subset of tools (not shown) for specific functions in each aspect. Compared to FIG. 3 that includes a text tool 309, the drawing or art software application in FIG. 4 may not require a text tool to create a text object, as further described below. At one moment, a user wants to draw a line, so the user selects the drawing tool 405 by moving his/her mouse to the corresponding position of the drawing tool, as indicated by the dotted circle around the drawing tool 405. The user may then begin to draw a line by moving the mouse to an area for drawing. After a line 411 is drawn, the mouse stops at an ending position of the drawn line 411, as indicated by the mouse pointer 415 displayed on the display screen. At this moment, the user may want to input certain text for his/her project. The user can create a text object on-site without requiring a text tool as shown in FIG. 3. For instance, the user may directly press a string (Unicode) character on a keyboard for the client device 103, and a text object 419 can be automatically created with the character included therein. The user does not need a back-and-forth toggle between the tool section and the current working area. In addition, the user does not need to move to another area to create a text object. Instead, the text object can be directly created on-site (e.g., at a location wherein the mouse pointer resides). This greatly saves the time required to frequently move the mouse in order to create a text object, like existing drawing or art software applications do. Further, since the text object is created on-site even there is a non-text object (e.g., the drawn line 411), the flexibility in creating a text object can be increased.

It is to be noted that, in some implementations, a user may not require to use a drawing tool to create a drawing object. For instance, a user may just click the mouse at a location he/she wants to draw a line, and then move (e.g., drag) the mouse to draw a line following a pattern that he/she wants to. That is, in FIG. 4, instead of selecting the drawing tool 405, the user may click the mouse at the starting position 421 of the line 411, and begin to drag the mouse to draw the line 411. This can then further save the time of the user to switch between different types of objects, e.g., between text objects and non-text objects, in a drawing or art project. Accordingly, in some implementations, an on-site text input component 105 may additionally include a drawing object creation module (not shown in FIGS. 2A-2B) that is configured to automatically create a drawing object at a location where the mouse is clicked, without requiring a user to move the mouse to a tool section to select a drawing tool. In some implementations, the pattern (e.g., a click of the Esc button, a click of the mouse outside the created drawing object area, etc.) used for ending a text object inputting may be also used to end a drawing object. Alternatively, a drawing object may be ended when a user does not move the mouse anymore. In some implementations, if a user accidentally clicks the mouse and the user actually does not want to draw a line, the user then does not move the mouse at all. At this moment, the drawing object created through the accidental mouse click can be automatically removed since the user does not move the mouse at all after clicking the mouse.

FIG. 5 shows another exemplary on-site text input process in a collaborative environment. In FIG. 5, a drawing or art software application is running on a host device and/or collaborator device, for example, an application window 503 is showing on a display screen 501 of the host device or a display screen 502 of the collaborative device. The drawing or art software application may include a plurality of tools for drawing. For example, as illustrated in the upper part of FIG. 5, the drawing or art software application may include a drawing tool 505 and an editing tool 507, where each tool may include a subset of tools (not shown) for specific functions in each aspect. At one point, a host has created an on-site text object 519, and inputted text “End” right after the creation of the text object. At the moment that the host is typing “End”, the collaborative device also shows the created text object and the text inputted on-site by the host. The created text object 519 may be displayed in a temporary text field, as indicated by the dotted box around the inputted text “End.” The collaborative device may also include a similar field that keeps updating the text typed into the temporary text field from the host device, as shown in the dotted box 521 in the lower part of FIG. 5. Although not shown, the collaborator may also input text in the temporary text field displayed on the collaborative device if he/she is permitted, which are then also transmitted back to the host device in real-time so that the host can see what the collaborator is typing from his/her side. In some implementations, after ending the text input on the created text object 519/521, the temporary text field displayed on the host device or collaborative device may be removed and replaced with a real text object. For instance, if the word “End” is the only text inputted into the created text object 519/521, the real text object “End” will be displayed on the host device and the collaborator device, e.g., without a dotted box (or without another formatting (e.g., a grayed area, etc.)) that indicates a temporary text field.

As can be also seen from FIG. 5, the text “End” is inputted at the exact position where the drawn line 511 ends in FIG. 5, which is different from FIG. 3, in which the text object 319 is created at a different location from the ending position of the drawn line 311. This may offer certain advantages for the disclosed on-site text input component 105, e.g., simply the content required for input into the created text object. For example, if the drawn line 511 is a route for a map, which has an ending point, the inputted text “End” alone may excellently explain the ending point of the route, especially when there is also a text object “Start” (not shown) at the starting point of the drawn line 511. However, if “End” must be inputted at a location other than the ending point of the drawn line (e.g. the drawn line 311 in FIG. 3, in which the created text object 319 must be located in a different area), then the input text “End” alone at such location may be confusing, and thus additional words (e.g., “the above ending point of the line is the end of the route”) may be required or an arrow may be required to offer a better explanation what “End” actually refers to in the drawing or art project. Therefore, by increasing the flexibility of placing a created text object in any desired area or location, the disclosed on-site text input component 105 may simplify the content of the text inputted into the created text object and/or avoid confusion caused by placing inputted text at an undesired location, which is especially important for effective collaboration in a drawing or art project, since extra communications and/or data transmission can be prevented.

The following describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

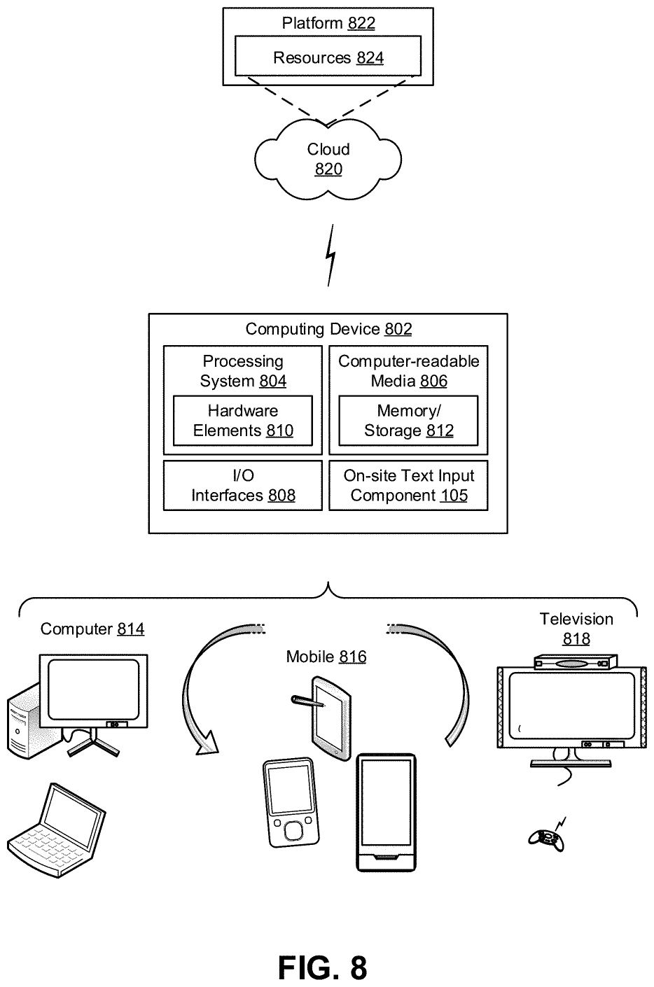

In portions of the following description, reference may be made to the examples of FIGS. 1-5. In at least some implementations, methods 600 and/or 700 may be performed by a suitably configured computing device such as computing device 103 of FIG. 1 having an on-site text input component 105 or as described in relation to FIG. 8.

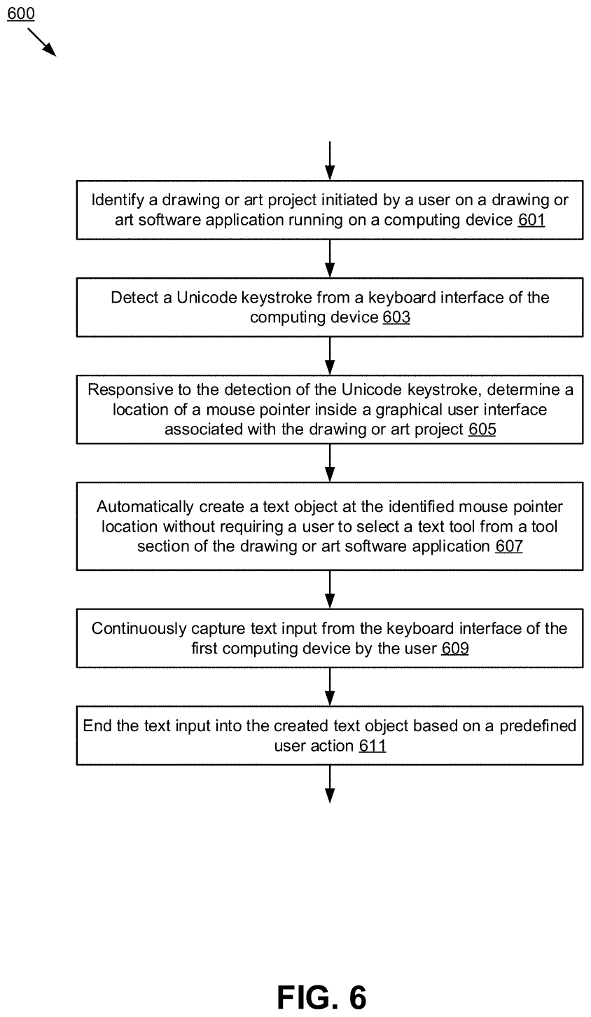

FIG. 6 is a flow chart of an example method 600 for inputting text on-site in a drawing or art software application. In step 601, a drawing or art software application and a drawing or art project initiated by a user are identified. The drawing or art project may include at least one text object and at least one non-text object that have been created or are to be created by the user. The drawing or art software application may be identified based on a list of software applications that contain a mix of text objects and non-text objects. In some implementations, the drawing or art software application may be automatically identified if the disclosed on-site input component for on-site text input is integrated into (e.g., as a plug-in or extension tool) or coupled to a drawing or art software application.

In step 603, a Unicode keystroke from a keyboard interface of the computing device is detected. In some implementations, when the user is working on the drawing or art project, the user activities including the keypress events and the mouse clicks and mouse movements are continuously monitored. Since keypresses corresponding to different keys return different signals, a Unicode keystroke can be easily identified or detected if the user presses a Unicode character key from the keyboard interface of the computing device. Here, the Unicode character key (or simple Unicode key or string key) refers to any alphanumeric key or any punctuation key. Once the Unicode keystroke is detected, an on-site text object is prompted to be created.

In step 605, responsive to the detection of the Unicode keystroke, a location of a mouse pointer inside a graphical user interface associated with the drawing or art project is then determined. In some implementations, to create a text object on-site, the mouse pointer location is first determined. The mouse pointer may be located based on the mouse clicks and mouse movements when the user is working on the drawing or art project. During these mouse movements and clicks, certain measures including the location information may be also returned to the operating system and/or the drawing or art software application of the computing device, which can then be used to determine the mouse pointer location at the moment that Unicode keystroke is detected. In one example scenario, the user may just have finished drawing a line, and want to input text right after. At the moment that the user presses the corresponding Unicode key(s), the mouse pointer may be identified to be located at the exact ending position of the drawn line, as shown in FIGS. 4-5.

In step 607, a text object is automatically created at the determined mouse pointer location without requiring the user to select a text tool to create the text object. That is, the text object can be created on-site in a natural way by the user without requiring him/her to toggle between the text tool and the site to create the expected text object. This can save the mouse movements during the creation of the text object. In addition, the text object may be created without requiring the user to click at the targeted location to initiate the creation of the text object, while other existing drawing or art software applications do require such mouse click. This then additionally saves the mouse activities during the creation of the text object. As described above, the text object can be created on-site, which means that the text object can be created at a location even where a non-text object is present. This then does not require the user to move the mouse to another different location, which further saves the mouse movements.

In step 609, the text inputting is continuously captured in the created text object. That is, the text inputted by the user is continuously entered into the created text object. In some implementations, the size of the created text object keeps expanding when the user keeps typing text into the created text object. In some implementations, the font size of the inputted text inside the created text object may be set to default, and/or may be automatically or manually adjusted if the size of the text object cannot expand further due to the limited space.

In step 611, the text input is ended if a predefined user action is identified. For instance, if the user clicks the mouse outside the created text object area or the user presses the Esc button, the text inputting into the created text object may be then ended. That is, the text will not be entered into the created text object. At this moment, the user may continue to work on his/her drawing objects or create another text object. In some implementations, if the user wants to continue to work on the ended text object within a short period of time, the user may reactivate the ended text object, e.g. by clicking the ended text object. At this moment, text may be continuously inputted into the reactivated text object from the previous ending position of the text object. In some implementations, after a certain period of time after ending the text inputting of the created text object, the inputted text object may be layered, which means that the text object may be not subjected to further modification (e.g., continuous text inputting).

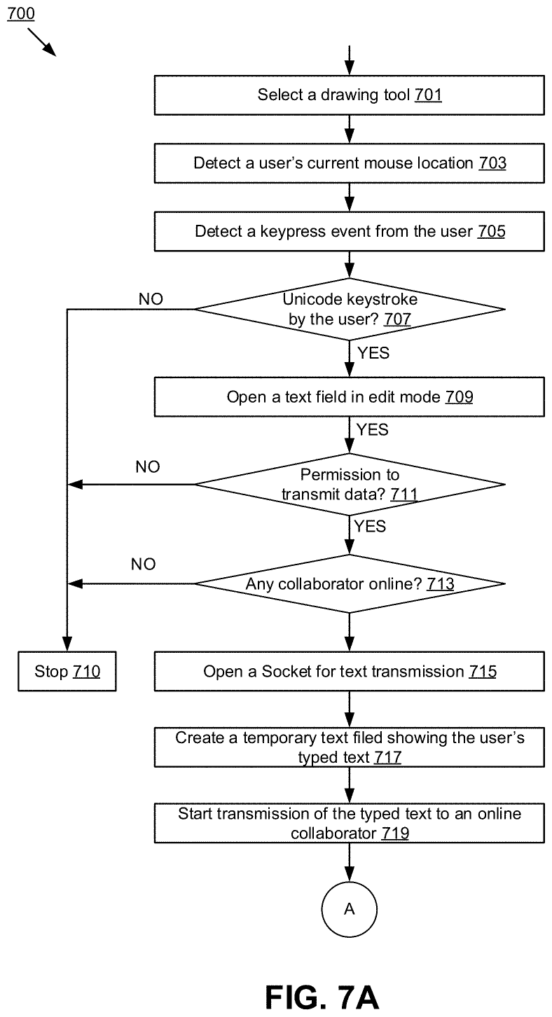

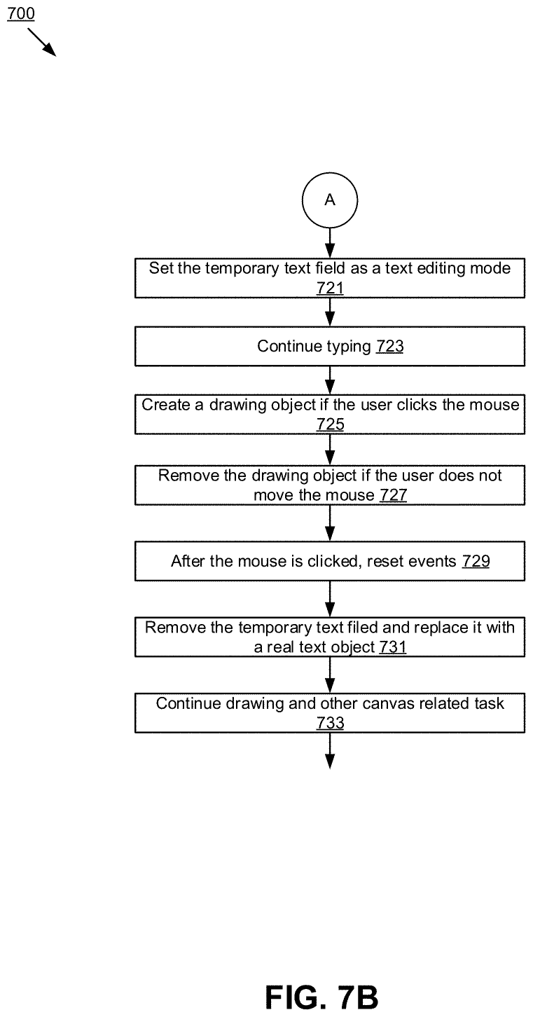

FIGS. 7A and 7B collaboratively illustrate a flow chart of another example method 700 for inputting text on-site in a drawing or art software application. Method 700 may be implemented in a working environment that allows a collaboration between different users on a drawing or art project.

In step 701, a user selects a drawing tool. For example, the user may select a drawing tool 505 to draw a line 511, as illustrated in FIG. 5.

In step 703, the user's current mouse location is detected. For example, after finishing drawing the line 511, the user's mouse may be located at the end of the drawn line 511 at this moment.

In step 705, a keypress event from the user is detected. For example, the user intends to input text, and thus press a key corresponding to the input text.

In step 707, it is determined whether the pressed key is a Unicode keystroke. For example, if an alphanumeric key or a punctuation key is pressed by the user, it may be determined that the user has pressed a Unicode character key. The method then proceeds to step 709. Otherwise, the method 700 may stop (i.e., proceed to step 710 in FIG. 7A).

In step 709, a text field is opened in editing mode. The text field in the editing mode may be opened in the mouse pointer location determined in step 703. That is, the text field may be opened on-site, which does not require the user to move the mouse to a text tool section to open the text field. For example, the text field corresponding to the created object 519 may be in the editing mode.

In step 711, it is determined whether the user has permission to transmit data. For example, the user may or may not have subscribed to a service allowing collaboration of a drawing or art project between different users, or the user device may or may not be equipped with a data transmission capacity. At this moment, the user profile may be checked to see whether the user has subscribed to the service, or the user device may be checked for data transmission capacity. If the user has not subscribed to the service or the user device does not allow data transmission at this moment, the method 700 proceeds to step 710 to stop the process. Otherwise, the method 700 may proceed to step 713.

In step 713, it is determined whether there is any collaborator available. The user profile may include a list of collaborators that the user normally works with. Based on the profile, it can be determined whether there is any collaborator online. If there is no collaborator online, the method may stop at step 710. Otherwise, the method 700 may proceed to step 715. In some implementations, a preferred collaborator may be identified based on the user profile.

In step 715, a Socket is opened for text transmission. That is, a Socket-based communication channel may be established between the user and one of the available collaborators (e.g., the preferred collaborator) or two or more collaborators if they are willing to collaborate.

In step 717, a temporary text field is created at the site of the opened text field. In some implementations, the temporary text field instead of a real text object is used here, mainly to facilitate the data transmission through the established Socket-based communication channel. The created temporary text field may show every character being typed by the user, which is also transmitted to the collaborator character-by-character in real-time.

In step 719, the text transmission to the collaborator is started. The text transmission is started instantly when the user starts to type text. The text is transmitted character-by-character in real-time so that the collaborator can instantly see what the user is typing.

In step 721, the temporary text field is set to the editing mode and is labeled as “in editing mode.” That is, during the process of typing, the user can delete, backspace, etc., so that the typed text is still subjected to revision in the temporary text field created in step 717. In addition, by labeling the temporary text field in the editing mode, the collaborator may realize that he/she can edit the transmitted text from his/her side, too.

In step 723, the user continues typing. The typing can be in the editing mode as just described.

In step 725, the user may click the mouse to create a drawing object. No mouse movement may be required in the process of creating the drawing object. That is, the user needs not to move to the drawing tool section to select the drawing tool to create a drawing object. Instead, the drawing object may be created on-site by just clicking the mouse. No mouse movement is required for the user to create the drawing object.

In step 727, if the user does not move the mouse, the created drawing object is removed. That is, after the mouse is clicked and the drawing object is created in step 725, if the user does not move the mouse at all, this means that the user does not actually work on the created drawing object. At this moment, the created drawing object may be removed. It is to be noted that, in some implementations, the user may work on the drawing object created on-site by moving the mouse after clicking the mouse (e.g., the user may drag the mouse to draw a line, a circle, a square). The drawing may be also transmitted in real-time to the collaborator at this moment. In the case that the user does not move the mouse after clicking the mouse, it means that the mouse click may be an accident, or the user may have changed his or her mind after clicking the mouse. For any reason, the drawing object created by the mouse click can be removed if no further mouse movement occurs.

In step 729, the user clicks the mouse to reset the event. For example, the user may click the mouse outside the temporary text field, so that the text input into the temporary text field is ended. Here, an event reset may mean that the current text object is ended, and a new task may begin in the next.

In step 731, the temporary text field is removed and replaced with a real text object. That is, after the text input is ended, the data transmission is not continued, and the inputted text can now be displayed as a real text object.

In step 733, the user continues drawing or other canvas related tasks. That is, the user may begin his or her new task after ending the text inputting into the created text object on-site. For instance, the user may draw another non-text object, or work on editing an existing non-text object (e.g., a drawing object), and so on. A canvas refers to a graphic user interface of the drawing or art software application where the user works on his/her drawing or art project.

The method 700 is provided for exemplary purposes. In real applications, some steps can be omitted, or additional steps can be added, which is not limited in the present disclosure. In addition, the order for performing steps 701-733 is not limited.

FIG. 8 illustrates an example system 800 that, generally, includes an example computing device 802 that is representative of one or more computing systems and/or devices that may implement the various techniques described herein (e.g., on-site text input or object drawing as described in FIGS. 4-7). The computing device 802 may be, for example, a server (e.g., an on-site text input server 101) of a service provider, a device associated with a client (e.g., a client device 103), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit (ASIC) or other logic devices formed using one or more semiconductors. The hardware elements 810 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random-access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media, e.g., Flash memory, a removable hard drive, an optical disc, and so forth. The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage devices, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 810 and computer-readable media 806 are representative of modules, programmable device logic and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through the use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created, and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This is illustrated through the inclusion of the on-site text input component 105 on the computing device 802. The functionality represented by the on-site text input component 105 and other modules/applications may also be implemented all or in part through the use of a distributed system, such as over a “cloud” 820 via a platform 822 as described below.

The cloud 820 includes and/or is representative of a platform 822 for resources 824. The platform 822 abstracts the underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device implementation, implementation of functionality described herein may be distributed throughout the system 800. For example, the functionality may be implemented in part on the computing device 802 as well as via the platform 822 that abstracts the functionality of the cloud 820.

Although the techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter, and other equivalent features and methods are intended to be within the scope of the appended claims. Further, various different implementations are described, and it is to be appreciated that each described implementation can be implemented independently or in connection with one or more other described implementations.

What is claimed is:

1. A system for inputting text on-site in a drawing or art software application, the system comprising:
a processor; and
a memory, coupled to the processor, configured to store executable instructions that, when executed by the processor, cause the processor to:
identify a drawing or art project initiated by a first user on the drawing or art software application running on a first computing device;
detect a Unicode keystroke from a keyboard interface of the first computing device;
responsive to the detection of the Unicode keystroke, determine a first location of a mouse pointer inside a graphical user interface associated with the drawing or art project; and
automatically create a text object at the identified first mouse pointer location without requiring the first user to select a text tool from a tool section of the drawing or art software application.

2. The system of claim 1, wherein the executable instructions further include instructions that, when executed by the processor, cause the processor to:
detect a mouse click from a mouse associated with the first computing device;
responsive to the detection of the mouse click, determine a second location of the mouse pointer inside the graphical user interface associated with the drawing or art project; and
automatically create a drawing object at the identified second mouse pointer location without requiring the first user to select a drawing tool from the tool section of the drawing or art software application.

3. The system of claim 1, wherein the detected Unicode keyboard stroke follows a user operation, on the drawing or art project, by the first user using a drawing tool of the drawing or art software application.

4. The system of claim 3, wherein the identified first location of the mouse pointer inside the graphical user interface corresponds to an ending position of the user operation using one of the drawing tool or the shape tool.

5. The system of claim 1, wherein, to detect the Unicode keystroke from the keyboard interface of the first computing device, the executable instructions further include instructions that, when executed by the processor, cause the processor to:
detect keypress events of the first computing device performed by the first user; and
detect the Unicode keystroke from the keyboard interface based on the keypress events by the first user.

6. The system of claim 1, wherein the executable instructions further include instructions that, when executed by the processor, cause the processor to:
continuously capture text input from the keyboard interface of the first computing device by the first user; and
instantly display the text input by the first user on the created text object.

7. The system of claim 1, wherein the executable instructions further include instructions that, when executed by the processor, cause the processor to:
identify a predefined user action from the first user, wherein the predefined user action indicates an ending of the text input into the created text object; and
end the text input into the created text object based on the predefined user action.

8. The system of claim 7, wherein the predefined user action comprises one of the following user operations: a mouse click outside the created text object, or a pressing of an Esc button on the keyboard interface.

9. The system of claim 1, wherein the executable instructions further include instructions that, when executed by the processor, cause the processor to:
determine that the first user has permission to collaborate with others on the drawing or art project;
determine that a second user is available for collaboration with the first user on the drawing or art project; and
transmit in real-time the text, input into the created text object by the first user, to a second computing device associated with the second user.

10. The system of claim 9, wherein the executable instructions further include instructions that, when executed by the processor, cause the processor to:
before transmitting the text to the second computing device, establish a Socket-based data communication channel between the first computing device and the second computing device; and
transmit the text to the second computing device in real-time through the Socket-based data communication channel.

11. The system of claim 10, wherein, to transmit the text to the second computing device in real-time, the executable instructions further include instructions that, when executed by the processor, cause the processor to:
create a temporary text field that displays the text input into the created text object; and
transmit text in the temporary text field in real-time to the second computing device, to allow each typing input by the first user to be transmitted in real-time to the second computing device.

12. The system of claim 11 wherein the executable instructions further include instructions that, when executed by the processor, cause the processor to:
after the text input into the created text object is ended, remove the created temporary text field; and
replace the temporary text field with a real text object containing the text input into the created text object.

13. The system of claim 1, wherein the drawing or art project comprises a creation of at least one text object.

14. The system of claim 13, wherein the drawing or art project comprises a creation of at least one non-text object.

15. The system of claim 14, wherein the executable instructions further include instructions that, when executed by the processor, cause the processor to:
automatically layer the at least one non-text object and the at least one text object according to a size of each object.

16. The system of claim 1, wherein the Unicode keystroke corresponds to one of an alphanumeric key or a punctuation key.

17. A system for inputting text on-site in a drawing or art software application, the system comprising:
a processor; and
a memory, coupled to the processor, configured to store executable instructions that, when executed by the processor, cause the processor to:
identify a drawing or art project initiated by a first user on the drawing or art software application running on a first computing device;
detect a mouse click from a mouse associated with the first computing device;
responsive to the detection of the mouse click, determine a first location of a mouse pointer inside a graphical user interface associated with the drawing or art project; and
automatically create a drawing object at the identified first mouse pointer location without requiring the first user to select a drawing tool from a tool section of the drawing or art software application.

18. The system of claim 17, wherein the executable instructions further include instructions that, when executed by the processor, cause the processor to:
detect a Unicode keystroke from a keyboard interface of the first computing device;
responsive to the detection of the Unicode keystroke, determine a second location of the mouse pointer inside the graphical user interface associated with the drawing or art project; and
automatically create a text object at the identified second mouse pointer location without requiring the first user to select a text tool from the tool section of the drawing or art software application.

19. A method for inputting text on-site in a drawing or art software application, comprising:
identifying a drawing or art project initiated by a first user on the drawing or art software application running on a first computing device;
detecting a Unicode keystroke from a keyboard interface of the first computing device;
responsive to the detection of the Unicode keystroke, determining a first location of a mouse pointer inside a graphical user interface associated with the drawing or art project; and
automatically creating a text object at the identified first mouse pointer location without requiring the first user to select a text tool from a tool section of the drawing or art software application.

20. The method of claim 19, further comprising:
detecting a mouse click from a mouse associated with the first computing device;
responsive to the detection of the mouse click, determining a second location of the mouse pointer inside the graphical user interface associated with the drawing or art project; and
automatically creating a drawing object at the identified second mouse pointer location without requiring the first user to select a drawing tool from the tool section of the drawing or art software application.
